(19) United States
(12) Patent Application Publication
(10) Pub. No.: US 2026/0286139 A1
(43) Pub. Date: Sep. 24, 2026

(54) ARCHITECTURAL COATING COMPOSITIONS

(71) Applicant: Rohm and Haas Company, Collegeville, PA (US)

(72) Inventors: Katherine Elbert, Philadelphia, PA (US); Michael W. Leonard, Collegeville, PA (US); William J. Fabiny, Harleysville, PA (US)

(21) Appl. No.: 19/475,961

(22) PCT Filed: Apr. 17, 2024
(86) PCT No.: PCT/US2024/024856

§ 371 Date: Oct. 16, 2025

Related U.S. Application Data
(60) Provisional application No. 63/500,946, filed on May 9, 2023.

(51) Int. Cl. C09D 5/33; C09D 7/61; C09D 133/06; C09D 133/26

(52) U.S. Cl. CPC C09D 5/004; C09D 7/61; C09D 133/064; C09D 133/26

(57) ABSTRACT

Aqueous coating compositions for roofs desirably have both high solar reflectance and low water swelling. They contain a filler, which includes a high-reflectance inorganic pigment like titanium dioxide to provide better solar reflectance, and a binder, both emulsified in an aqueous solvent. The amount of high reflectance pigment in the filler can be reduced if the binder is an opacifying acrylic polymer (OAP) binder. Unexpectedly, coatings with the OAP binder exhibit only moderate and acceptable levels of water swelling.

### FIELD

This invention relates generally to the field of roof coatings.

### INTRODUCTION

Roof coatings are applied to a substrate that forms part of the roof of a building. Roof coatings are typically applied as an aqueous coating composition that comprises:
A water-insoluble filler. Many fillers contain inorganic powders such as silica or calcium carbonate, aluminum trihydrate, aluminosilicates and/or inorganic pigments.
A binder that adheres the filler to an exterior substrate. The binder is typically a film-forming polymer that is insoluble but forms an emulsion in water, such as an acrylic polymer.
Optionally other additives such as emulsifiers, stabilizers, thickeners, surfactants, hydrophobic additives, levelling and coalescing agents, antioxidants, UV stabilizers or other additives.
An aqueous solvent that suspends the filler and binder and any other components of the coating. The term “solvent” does not imply that the filler or binder dissolve in the aqueous solvent. Typically, the filler and binder are insoluble in the aqueous solvent, but the filler is suspended in the solvent and the binder forms an aqueous emulsion.
   The fillers, binders and other water-insoluble additives are referred to as “dry components” or “solids”. The quantity of aqueous solvent is typically high enough to fully wet the solid components and to provide a coating composition whose viscosity is suitable to apply by ordinary means such as spraying, brushing or rolling. The quantity of aqueous solvent is typically low enough that the aqueous coating composition can dry quickly to leave a solid coating.

The quantity of dry components in coatings formulations is often described using “pigment volume content” (“PVC”), which is the volume of pigment and filler as a percent of the total volume of solid components in the coating formulation. PVC is calculated by Formula 1:

$$PVC = \frac{V \text{?} \cdot V \text{?}}{V \text{?} + V \text{?} + V \text{?}} \times 100 \qquad ( 1 )$$

$$\text{?} \text{indicates text missing or illegible when filed}$$

wherein Vp is the dry volume of pigment, Ve is the dry volume of filler and Vb dry is the dry volume of binder.

Roof coatings and coating compositions desirably meet many different requirements. For example, ASTM D-6083 sets standards for roofing coatings that have acrylic binders, which standards relate to solids content, viscosity, elongation, tensile strength, water permeance, water swelling, weathering, adhesion, fungal resistance, tear resistance and low-temperature flexibility.

In addition, roof coatings can contribute to keeping buildings cool by having a high solar reflectance and a high dirt pick-up resistance (because dirt-pick up darkens the coating and reduces solar reflectance over time). It is common to add high-reflectance inorganic pigments such as titanium dioxide to the filler in order to increase its solar reflectance. However, high-reflectance inorganic pigments such as titanium dioxide are costly, and their production has environmental impacts.

In recent years, it has been known to reduce the quantity of high-reflectance inorganic pigments in a coating by adding an opacifying polymer (OP, also known as a hollow-sphere polymer) to the filler. OPs increase reflectance in two ways. First, the OPs help to space out the high-reflectance inorganic pigments and prevent crowding. Second, the OPs scatter light because of the interface between the polymer sphere and the air inside the sphere. See, for example, “25 Years of Hollow-Sphere Hiding Technology”, Paint & Coatings Industry Magazine (2005) at https://www/pcimag.com/articles/87259-25-years-of-hollow-sphere-hiding-technology and “Pull off the TiO₂ balancing act in architectural coatings” published by BASF SE at https://insights.basf.com/home/article/read/pull-off-the-tio2-balancing-act-in-architectural-coatings.

However, the use of opacifying polymer (OP) in roofing has been limited by the need to meet other requirements for roof coatings. High levels of OP in the filler may increase the water-swelling capacity of the resulting coating. As a result, the use of OPs as a method to enhance the effectiveness of high-reflectance inorganic pigments is disfavored.

It is desirable to achieve more reduction of high-reflectance inorganic pigments while maintaining acceptable water swelling performance.

It is further desirable to maximize the time that the coating can maintain brightness and reflectivity, called Dirt Pick-Up Resistance (DPUR). High DPUR maintains aesthetics and energy efficiency of the coating. Roof coatings are generally formulated with softer low-Tg binders to reduce cracking from the repeated expansion and contractions during temperature cycles that roofs are exposed to. However, the low-Tg binders are also susceptible to high dirt pick-up. The effect for roof coatings is described in Dirt-Pickup Resistance in Low-Tg Elastomeric Coatings, PAINT AND COATING RESINS & POLYMERS, May 2022. Available at https://www.pcimag.com/articles/110073-dirt-pickup-resistance-in-low-tg-elastomeric-coatings. It is desirable to find coatings that have a low-Tg binder to resist thermal cracking but also have high DPUR.

### SUMMARY

Some opacifying acrylic polymers (OAP) can be effectively used as a binder and a filler. The OAP binders contain two different polymers, that perform two different functions. Particles of OAP binder contain an inner shell of polymer with a glass-transition temperature above 50° C. (high-Tg polymer), which encloses one or more void spaces. The high-Tg polymer is usually not film forming but retains its shape and maintains the void as the binder dries. Particles of the OAP binder also contain an outer shell of film-forming polymer adhered directly or indirectly on the inner shell. The outer shell polymer has a glass-transition temperature below 50° C. (low-Tg polymer) and is capable of coalescing to form a film under conditions that the binder would ordinarily be applied, such as air atmosphere at atmospheric pressure temperatures of 0° C. to 35° C. The OAP binders can be used in concentrations that can substantially reduce the need for high-reflectance inorganic pigment. Unexpectedly, the OAP binders produce a film with low water-swelling, unlike films that contain OP fillers. In some embodiments, the resulting film also has high DPUR.

One aspect of this invention is an aqueous coating composition that comprises:
a. A water-insoluble filler that contains from 5 weight percent to less than 20 weight percent of high-reflectance inorganic pigment;
b. An OAP binder; and
c. An aqueous solvent,
   wherein the aqueous coating composition has a pigment volume content of no more than 55 percent.

A second aspect of this invention is a process to coat a roof substrate comprising the steps of (1) applying the aqueous coating composition of the first aspect to a substrate that forms part of a roof and (2) permitting the aqueous coating composition to dry, under conditions such that the filler and binder adhere to the substrate and form a dry coating on the substrate.

A third aspect of the invention is a coated substrate that forms part of a roof, which comprises a substrate and a dry coating adhered directly or indirectly to the substrate and which is made by the process of the second aspect, wherein the dry coating comprises:
a. A water-insoluble filler that comprises from 5 weight percent to less than 20 weight percent of high-reflectance inorganic pigment; and
b. An OAP binder,
wherein the dry coating has a pigment volume content of no more than 55 percent.

A fourth aspect of this invention is a coated substrate that forms part of a roof, which comprises a substrate and a dry coating adhered directly or indirectly to the substrate, wherein the dry coating comprises:
a. A water-insoluble filler that comprises from 5 weight percent to less than 20 weight percent of high-reflectance inorganic pigment; and
b. An OAP binder,
and wherein the pigment volume content of the coating is no more than 55 percent.

The roof coatings of this invention can have good reflectance properties using significantly lower levels of titanium dioxide. Unexpectedly, the roof coatings also have good resistance to swelling caused by exposure to water. Further, they can also have good dirt-pickup resistance with reduced need for additives such as benzophenone, benzophenone derivatives, or other photoactive DPUR additives.

### DETAILED DESCRIPTION

The present invention uses an aqueous coating composition that comprises a filler, an OAP binder and an aqueous solvent. In some embodiments, the aqueous coating composition may also contain other components such as pigments, thickeners, surfactants, hydrophobic additives, levelling and coalescing agents, antioxidants, UV stabilizers or other additives known for out-door coatings.

### Solvent

The coating composition contains an aqueous solvent-water, optionally with additives such as acid or base. In some embodiments, the pH of the aqueous solvent is at least 5 or at least 5.5 or at least 6 or at least 6.5 or at least 6.75 or at least 6.9. In some embodiments, the pH of the aqueous solvent is at most 9.8 or at most 8.5 or at most 8 or at most 7.7 or at most 7.5 or at most 7.2. It is known to adjust the pH of an aqueous coating composition in order to achieve a desired viscosity.

### Filler

The aqueous coating composition contains a filler that is insoluble in water. From 5 to 20 weight percent of the filler is a high-reflectance pigment. The remainder of the filler is low-reflectance filler.

Fillers are solid particles added to a coating to improve properties and/or reduce cost. Suitable fillers for coatings are known and commercially available. Examples of suitable fillers include various powdered minerals such as calcium carbonate, dolomite, feldspar, mica, quartz, silica and silicates, talc and metal carbonates, some clays such a kaolin, diatomaceous earth, glass powder and microspheres and aluminum hydroxide. Fillers and their production and use are described in publications such as: Gysau, Fillers for Paints (3rd Ed.), Vincentz Network GmbH & Co. (2017); and “Functional Silicate Fillers: Basic Principles”, Painting & Coatings Industry (Aug. 1, 2002) (https://www.pcimag.com/articles/84909-functional-silicate-fillers-basic-principles).

High-reflectance inorganic pigments that are useful in fillers are also known and commercially-available. High reflectance pigments have a white color and a high refractive index. See for example “Titanium Dioxide for Coatings”, publication C-10416-2(2/19) published by The Chemours Company FC.

White color can be measured based on brightness (Y). In some embodiments, the high-reflectance inorganic pigment has a dry brightness (Y) of at least 90. In some embodiments, the high-reflectance inorganic pigment has a dry-brightness of at least 92 or at least 94 or at least 95 or at least 96. There is no maximum desired reflectance for the high-reflectance inorganic pigment, but 100 percent is the practical limit. On the other hand, in some embodiments, the low-reflectance filler may have a dry brightness of less than 90. In some embodiments, the low-reflectance filler has a dry brightness of no more than 88 or no more than 86. In some embodiments, the low-reflectance filler has a dry brightness of at least 50 or at least 60 or at least 70 or at least 80. Examples of low-reflectance fillers include silica and natural calcium carbonate.

In some embodiments, the high reflectance pigment has a refractive index of at least 1.9 or at least 2 or at least 2.2 or at least 2.4 or at least 2.5 or at least 2.6. There is no maximum desired refractive index, but in many embodiments refractive index above 3 is unnecessary. In some embodiments, the ordinary filler has refractive index below 1.9 or no more than 1.8 or no more than 1.7.

Particle size is known to have an impact on the refractive index of pigments. See for example “Titanium Dioxide for Coatings”, publication C-10416-2 (2/19) published by The Chemours Company FC and Kumar et al., “Size Dependent Reflective Properties of TiO₂ Nanoparticles and Reflectors Made Thereof”, Vol. 7, No. 2 Digest Journal of Nanomaterials and Biostructures, 607-619 (2012). In some embodiments, the high-reflectance pigment has a smaller particle size, as compared with ordinary low-reflectance fillers. In some embodiments, the high-reflectance pigments have a median particle size of at least 0.1 micron or at least 0.2 micron or at least 0.3 micron. In some embodiments, the high-reflectance pigments have a median particle size of at most 1 micron or at most 0.8 micron or at most 0.6 micron or at most 0.5 micron. In some embodiments, low-reflectance fillers have a median particle size of no more than 25 micron or no more than 20 micron or no more than 15 micron or no more than 12 micron. In some embodiments, low-reflectance fillers have a median particle size of at least 1 micron or at least 3 micron or at least 5 micron or at least 8 micron. In many embodiments, fillers in coatings have an overall median particle size of no more than 30 micron.

Examples of high-reflectance inorganic pigment include titanium dioxide (particularly rutile phase titanium dioxide), barium sulfate and precipitated calcium carbonate. In many embodiments, the high-reflecting pigment is rutile titanium dioxide.

The filler contains from 5 to 20 weight percent high-reflectance inorganic pigment. In some embodiments, the filler contains no more than 18 weight percent high-reflectance inorganic pigment or no more than 15 weight percent or no more than 12 weight percent or no more than 10 weight percent or no more than 9 weight percent or no more than 8 weight percent. In some embodiments, the filler contains at least 6 weight percent high-reflectance inorganic pigment or at least 7 weight percent or at least 8 weight percent or at least 9 weight percent. For example, the filler may contain from 6 to 18 weight percent high-reflectance inorganic pigment or from 7 to 15 weight percent or from 8 to 12 weight percent.

### Binder

The aqueous coating composition contains an OAP binder. An OAP binder comprises both (1) a film forming polymer that forms a film as it dries on a substrate, plus (2) voids in the film forming polymer that are at least partially empty and capable of scattering light after the film-forming polymer dries.

The concept of “film-forming” polymers is well understood. “Film-forming” means that a substance is capable of forming a film upon application to a solid surface. The ability of polymers and their solutions or emulsions to be film-forming is known and described in publications such as: P. A. Steward et al., “An Overview of Polymer Latex Film Formation and Properties”, 86 Advances in Colloid and Interface Science at 195-267 (2000) and J. Guerts et al., “New Waterborne Acrylic Binders for Zero VOC Paints”, 5 J. Coating Technol. Res. at 57-63 (2008). Film forming polymer latexes generally contain suspended particles that can coalesce as they dry. Coalescence can arise from individual particles compacting, deforming, adhering to each other and/or having polymer chains diffuse with each other. Commonly, the film-forming ability of polymers increases with lower molecular weight and/or lower Tg and decreases with higher molecular weight and/or higher Tg.

Opacifying acrylic polymers are also known and described in references identified in the Background. When dry, they contain voids that can scatter light. However, film-forming polymers rarely contain voids because the coalescence of polymer to form films can also collapse voids in the polymer.

OAP binders are able to form films and retain voids because they contain two different polymers, that perform two different functions. Particles of OAP binder contain an inner shell of polymer with a glass-transition temperature above 50° C. (high-Tg polymer), which encloses one or more void spaces. The high-Tg polymer is usually not film forming but retains its shape and maintains the void as the binder dries. Particles of the OAP binder also contain an outer shell of film-forming polymer adhered directly or indirectly on the inner shell. The outer shell polymer has a glass-transition temperature below 50° C. (low-Tg polymer) and is capable of coalescing to form a film under conditions that the binder would ordinarily be applied, such as air atmosphere at atmospheric pressure and temperatures of 0° C. to 35° C.

OAP binders and processes to make them are known and reported in references such as U.S. Pat. Nos. 6,020,435, 7,939,572 B2 and 7,629,414 B2, and US Patent Publications US 2010/0010118A1 and US 2008/0171810 A1. In some processes, the high-Tg inner shell is first polymerized on an acidic polymer core in an aqueous emulsion. Second, the low-Tg outer shell is polymerized on the inner shell. Third, the inner shell is plasticized by monomers of the outer shell. Base in the aqueous emulsion reacts with the acidic polymer core, drawing water inside the inner shell and expanding the plasticized inner shell to create a water-filled void. Last, the plasticizing monomers are polymerized, wherein the polymer chains are incorporated into the final polymer particles. When the OAP binder dries, water migrates out of the void space to leave a light-scattering void.

In some embodiments, the high-Tg polymer in the inner shell has a glass transition temperature of at least 55° C. or at least 60° C. or at least 70° C. or at least 80° C. or at least 90° C. or at least 100° C. There is no maximum desired glass transition temperature, but glass transition temperature above 150° C. or 120° C. is rarely necessary. Examples of suitable high-Tg polymers that can be used in the inner shell include polystyrene, styrene-acrylic copolymers, and acrylic polymers. In some embodiments, the high-Tg polymer in the inner shell is a polystyrene polymer, which may be a homopolymer or a copolymer. In some embodiments the polystyrene polymer contains at least 80 weight percent units derived from styrene monomer or at least 85 weight percent or at least 90 weight percent. In some embodiments, the polystyrene polymer contains up to 100 weight percent units derived from styrene monomer. Comonomers for polystyrene copolymers are known, and common examples include but are not limited to vinyl toluene and methyl methacrylate. Emulsion polymerization of polystyrene is known and described in publications such as; U.S. Pat. Nos. 3,914,338A, 4,427,836A, 4,469,825A, 4,594,363A, 7,939,572B2, US20010009929A1, and Hollow polymer particles: a review by Ros Azlinawati Ramli, RSC Adv., 2017, 7, 52632. (https://pubs.rsc.org/en/content/articlepdf/2017/ra/c7ra10358a)

In some embodiments, the low-Tg polymer in the outer shell has a glass transition temperature of at most 45° C. or at most 40° C. or at most 30° C. or at most 20° C. or at most 10° C. or at most 0° C. or at most −10° C. or at most −15° C. or at most −20° C. or at most −25° C. There is no minimum desirable Tg, but Tg below −50° C. are seldom necessary.

In some embodiments, the low-Tg outer shell is an acrylic polymer. An acrylic polymer is a polymer or copolymer that contains repeating units derived from acrylic monomers. Acrylic monomers include acrylic acid, methacrylic acid and their esters. Exemplary esters used in acrylic monomers include alkyl esters such as alkyl groups containing from 1 to 8 carbon atoms or from 1 to 4 carbon atoms or in some cases methyl groups or ethyl groups. Particularly useful acrylic monomers are acrylic acid, methacrylic acid, butyl acrylate, 2 ethylhexyl acrylate, methyl acrylate, ethyl acrylate, methyl methacrylate and ethyl methacrylate.

Exemplary acrylic polymers may contain at least 70 weight percent repeating units derived from acrylic monomers, or at least 80 weight percent or at least 90 weight percent or at least 95 weight percent. Exemplary acrylic polymers may contain up 100 percent repeating units derived from acrylic monomers. Some exemplary acrylic polymers are copolymers containing units derived from two or more acrylic monomers, such as copolymers of butyl acrylate with methyl methacrylate and/or methacrylic acid. Some exemplary acrylic polymers may further contain repeating units derived from non-acrylic ethylenically unsaturated comonomers, such as vinyl acetate and similar vinyl esters or styrene.

It is known to make both high-Tg and low-Tg acrylic polymers. Increasing content of certain monomers such as methyl methacrylate is known to increase Tg of the resulting polymer, and increasing content of other monomers such as butyl acrylate is known to reduce Tg of the resulting polymer. In some embodiments, the low-Tg polymer in the outer shell contains at least 7 weight percent units derived from methyl methacrylate or at least 10 weight percent or at least 12 weight percent. In some embodiments, the low-Tg polymer in the outer shell contains at most 50 weight percent units derived from methyl methacrylate or at most 45 weight percent or at most 40 weight percent or at most 35 weight percent or at most 30 weight percent or at most 25 weight percent. In some embodiments, the low-Tg polymer in the outer shell contains at least 50 weight percent units derived from butyl acrylate or at least 60 weight percent or at least 65 weight percent or at least 65 weight percent or at least 65 weight percent. In some embodiments, the low-Tg polymer in the outer shell contains at most 93 weight percent units derived from butyl acrylate or at most 90 weight percent or at most 86 weight percent or at most 84 weight percent or at most 82 weight percent or at most 80 weight percent.

In some embodiments, the acrylic polymer may include cross-linking monomers. Examples of cross-linking monomers include but are not limited to acetoacetoxy ethyl methacrylate (AAEM), diacetoneacrylamide (DAAM, which may be crosslinked with adipic acid dihydrazide), and glycidyl methacrylate and other epoxies, which may be crosslinked in the presence of an amine functional group. The quantity of cross-linking should be kept low enough that the resulting polymer is still film forming. In some embodiments, the acrylic polymer contains no more than 10 weight percent cross-linking monomer, or no more than 6 weight percent or no more than 4 weight percent or no more than 2 weight percent. In some embodiments, the acrylic polymer contains 0 weight percent cross-linking monomer or at least 0.5 weight percent or at least 1 weight percent.

It may also be useful for the low-Tg polymer in the outer shell to remain non-molten in temperatures that exterior coatings are commonly exposed to. In some embodiments, the low-Tg polymer in the outer shell has a melting temperature of at least 60° C. or at least 75° C. or at least 80° C. or at least 95° C. or at least 110° C. There is no maximum desirable melting temperature, but temperatures above 200° C. are seldom necessary.

The high-Tg inner shell should be thick enough that the void space does not collapse after water migrates out during drying. In some embodiments, the weight ratio of high-Tg inner shell to low-Tg outer shell is at least 1:10 or at least 1:5 or at least 1:3. In some embodiments, the weight ratio of high-Tg inner shell to low-Tg outer shell is at most 1:1 or at most 1:1.5 or at most 1:2.

In some embodiments, the OAP binder particles have a median diameter of at least 200 nm or at least 250 nm or at least 300 nm or at least 320 nm. In some embodiments, the OAP binder particles have a median diameter of at most 1000 nm or at most 750 nm or at most 500 nm or at most 450 nm.

In some embodiments, the OAP binder is the only binder in the aqueous coating composition. In some embodiments, the binder of the aqueous coating composition contains a blend of the OAP binder and another binder polymer. Other binders are known and commercially available. They are described in publications such as “Paints” published by Department of Chemistry, University of York at https://www.essentialchemicalindustry.org/materials-and-applications/paints.html (Mar. 18, 2013). Examples of other binders include certain acrylic polymers, polyurethane polymers, styrene-acrylic polymers and vinyl-acrylic polymers. Examples of binders that are commercially available include acrylic polymers and polymer dispersions available from the Dow Chemical Company under the RHOPLEX™, PRIMAL™, PARALOID™, and MAINCOTE™ trademarks.

In some embodiments, the OAP binder makes up at least 20 weight percent of the binder or at least 40 or at least 60 or at least 80. In some embodiments, the OAP binder makes up 100 percent of the binder. In some embodiments, the OAP binder makes up no more than 90 weight percent of the binder or no more than 70 weight percent.

### Other Additives

Aqueous coating compositions may optionally contain other additives that are appropriate for architectural exterior coatings. Many such components are described in the publication Johan Bieleman (ed.), Additives for Coatings, published by WILEY-VCH Verlag GmbH (2000). Some examples of common additives are listed below. All of the additives listed below are commercially available.

The aqueous coating composition may optionally contain thickeners to make it easier to handle and apply. Examples of thickeners include inorganic materials such as certain clays and polymer thickeners, such as certain cellulose derivatives, starches, and acrylic polymers.

The aqueous coating composition may optionally contain surfactants for a number of purposes. Some surfactants are emulsifiers, wetting agents and dispersants, which help insoluble components to enter and remain in an emulsion or dispersion in the aqueous solvent. Some surfactants are antifoaming agents. Some surfactants can promote adhesion of the binder to the substrate.

The aqueous coating composition may optionally contain hydrophobic additives to improve its ability resist water infiltration. Examples of hydrophobic components may include waxes and polymers such as polypropylene.

The aqueous coating composition may optionally contain levelling and coalescing agents to provide complete coverage and a smooth surface on the roof. Examples of levelling additives include certain polyacrylate polymers, which have a low glass-transition temperature such as −20° C. or lower. Coalescing agents promote interaction of binder molecules as the coating dries on the substrate, to form a solid homogeneous film that does not redissolve when subjected to new water. Examples of coalescing agents include:
certain branched and cyclic paraffins,
certain esters such as 3-hydroxy-2,2,4-trimethylpentyl isobutyrate (TPiB), diesters of adipic acid (ADE), dimethyl phthalate (DMP), 2-hydroxypropyl ethylhexanoate (HPE) and benzyl benzoate, and
certain ether alcohols such as ethylene glycol butyl ether, propylene glycol butyl ether, dipropylene glycol butyl ether (DPB) and propylene and ethylene glycol phenyl ether (PPH and EPH

The aqueous coating composition may optionally contain antioxidants. Antioxidants may include a primary antioxidant such as certain amines or sterically-hindered phenols and/or a secondary antioxidant such as certain organophosphates or thioesters.

The aqueous coating composition may optionally contain light and ultraviolet (UV) stabilizers. Examples of light and ultraviolet (UV) stabilizers may include:
UV absorbers such as benzotriazoles and other compounds having coordinated double bonds; and
Sterically hindered amines such as compounds containing a 2,2,6,6-tetramethylpiperidine group;

The aqueous coating composition may optionally contain antifouling additives, such as 4,5-dichloro-2-octyl-4-isothiazolin-3-one (DCOIT), 2-n-octyl-4-isothiazolin-3-one (OIT) and zinc pyrithione (ZPT).

The aqueous coating composition may optionally contain one or more dirt pickup resistance additives, such as benzophenone or a benzophenone derivative wherein one or both of the phenyl rings can be substituted such as, for example, methyl 2-benzoylbenzoate, 4-methyl benzophenone, 4-hydroxy benzophenone, 4-amino benzophenone, 4-chloro benzophenone, 4-hydroxycarboxyl benzophenone, 4,4′-dimethyl benzophenone, 4,4′-dichloro benzophenone, 4-carboxymethyl benzophenone, 3-nitro benzophenone, substituted phenyl ketones such as substituted phenyl acetophenones. Benzophenone, methyl 2-benzoylbenzoate, and 4-methyl benzophenone are preferred.

The aqueous coating composition may optionally contain a small amount of volatile organic solvent to help maintain all ingredients dissolved or suspended until it is applied and dried.

### Coating Composition

The aqueous coating composition is made by mixing the filler, binder and other components in the aqueous solvent. In some embodiments, certain components may be mixed with water before being mixed with the other components; for example, the OAP binder is usually made as an emulsion and can conveniently be retained as an emulsion until it is mixed into the aqueous coating composition.

In some embodiments, the aqueous coating composition is mixed in two stages, as described in European Patent EP 2 217 667 B1. First, in a “grind” stage, the filler (including inorganic pigments) and optionally other ingredients are mixed with water to fully wet and blend the dry ingredients, fully disperse the pigments and prevent them from re-agglomerating. Second, in a “let down” stage, the binder emulsion and any remaining components are mixed in and blended to form a stable, homogeneous aqueous coating composition.

The quantity of filler, pigment and binder in the aqueous coating composition is such that the pigment volume content (PVC) of the aqueous coating composition is no more than 55 percent. In some embodiments, the PVC of the aqueous coating composition is no more than 52 percent or no more than 50 percent or no more than 48 percent or no more than 45 percent. In some embodiments, the PVC of the aqueous coating composition is at least 20 percent or at least 30 percent or at least 35 percent or at least 38 percent or at least 40 percent or at least 42 percent or at least 45 percent.

In some embodiments, the binder makes up at least 35 weight percent of the dry components in the aqueous coating composition (excluding solvent) or at least 40 weight percent or at least 42 weight percent or at least 45 weight percent. In some embodiments, the binder makes up at most 60 weight percent of the dry components (excluding solvent) or at most 55 weight percent or at most 52 weight percent or at most 50 weight percent.

In some embodiments, the pigments and fillers make up at least 40 weight percent of the dry components in the composition (excluding solvent) or at least 45 weight percent or at least 50 weight percent or at least 52 wight percent. In some embodiments, the pigments and fillers make up at most 60 weight percent of the dry components in the composition (excluding solvent) or at most 58 weight percent or at most 55 weight percent.

In some embodiments, the other additives collectively make up at least 0.2 weight percent of the coating components in the composition (excluding solvent) or at least 0.5 weight percent or at least 1 weight percent or at least 2 weight percent. In some embodiments, the other additives collectively make up at most 20 weight percent of the coating components in the composition (excluding solvent) or at most 10 weight percent or at most 8 weight percent or at most 6 weight percent.

The aqueous coating composition has sufficient aqueous solvent to wet the dry components and form a suspension that is practical to apply. In many embodiments, its viscosity is low enough to apply evenly by brush, roller or spray and high enough to minimize running and dripping after the aqueous coating composition is applied. In some embodiments, the quantity of water is minimized in order to minimize the time needed for the aqueous coating composition to dry.

In some embodiments, the aqueous coating compositions contain at least 40 weight percent dry components or at least 45 weight percent or at least 50 weight percent or at least 55 weight percent or at least 60 weight percent. In some embodiments, the aqueous coating compositions contain at most 75 weight percent dry components or at most 70 weight percent or at most 65 weight percent. In some embodiments, the aqueous coating compositions contain at least 25 weight percent aqueous solvent or at least 30 weight percent or at least 35 weight percent. In some embodiments, the aqueous coating compositions contain at most 60 weight percent aqueous solvent or at most 55 weight percent or at most 50 weight percent or at most 45 weight percent or at most 40 weight percent.

In some embodiments, the pH of the aqueous coating composition is at least 6 or at least 6.5 or at least 7. In some embodiments, the pH of the aqueous coating composition is at most 12 or at most 11.5 or at most 11.

In some embodiments, the aqueous coating composition has a viscosity at 25° C. of at least 70 KU or at least 80 KU or at least 85 KU or at least 90 KU. In some embodiments, the aqueous coating composition has a viscosity at 25° C. of at most 150 KU or at most 145 KU or at most 141 KU or at most 135 KU or at most 130 KU or at most 125 KU or at most 120 KU. In some embodiments, the aqueous coating composition has a viscosity at 25° C. of at least 200 cP or at least 1000 cP or at least 5000 cP or at least 10,000 cP or at least 12,000 cP. In some embodiments, the aqueous coating composition has a viscosity at 25° C. of at most 100,000 cP or at most 85000 cP or at most 60,000 cP or at most 40,000 cP.

### Method of the Present Invention and Coated Substrate

In the method of the present invention, the aqueous coating composition is applied to a substrate that forms part of a roof. Examples of appropriate substrates for a roof include any known roof surface, such as shingles, ceramic tiles, metal roofing, concrete, asphalt, foam, a polymer membrane or built-up roof (tar and gravel). In some embodiments, the roof surface comprises a membrane, such as ethylene propylene diene terpolymer (EPDM), thermoplastic polyolefin (TPO) or polyvinyl chloride (PVC).

Roof pitch is commonly expressed as vertical inches rise per 1 foot horizontal inch of run in a roof. In some embodiments, the roof has a steep pitch, such as 9:12 or greater. In some embodiments, the roof has a conventional pitch, such as from 4:12 to 9:12. In some embodiments, the roof has a low pitch, such as from 2:12 to 4:12. In some embodiments, the roof is flat or essentially flat, such as a pitch of less than 2:12. Some substrates, such as shingle and tiles, may be more common on conventional pitched roofs. Some substrates, such as membranes and built up roofs, may be more common on a flat or essentially flat roof.

The aqueous coating composition may be applied to the substrate by known means such as spraying, rolling or brushing. In most cases, it would be applied during dry weather with a temperature high enough for the aqueous solvent to evaporate quickly leaving the dry coating behind. In some embodiments, the temperature will be at least 0° C. or 5° C. or 10° C. or at least 15° C. Maximum temperature is not usually critical, but temperature is commonly below 50° C. or 45° C. or 40° C.

The aqueous coating composition is allowed to dry, leaving behind a solid dried coating on the substrate. The aqueous coating composition may be applied as a single coat, or two or more coats may be applied with each coat permitted to substantially dry before the next coat is applied.

The contents of the dry coating are essentially the same as the dry components of the aqueous coating composition. In some embodiments, the dry coating comprises no more than 5 weight percent water, or no more than 3 weight percent or no more than 1 weight percent or no more than 0.5 weight percent. There is no required content of water in the coating but in some cases, it may be impractical to remove solvent to a content below 0.01 weight percent.

In some embodiments, the average thickness of the coating is at least 10 mil (250 micron) or at least 20 mil (500 micron) or at least 30 mil (760 micron). In some embodiments, the average thickness is at most 120 mil (3000 micron) or 100 mil (2500 micron) or 75 mil (1900 micron) or 50 mil (1300 micron).

In some embodiments, the dry coating meets the water swelling limitations of ASTM D6083. In some embodiments, the 7-day water absorption of the dried coating (measured as described in the test methods) is at most 20 weight percent or at most 16 weight percent or at most 12 weight percent or at most 10 weight percent or at most 9 weight percent or at most 8 weight percent or at most 7 weight percent. There is no maximum desired minimum water absorption, but absorption below 5 weight percent may be unnecessary.

In some embodiments, the dry coating has an initial reflectance (Y) of at least 80 percent or at least 83 percent or at least 85 percent or at least 86 percent or at least 87 percent. There is no maximum desirable initial reflectance, but initial reflectance greater than 95 percent or 93 percent may be unnecessary.

In some embodiments, the dry coating retains at least 85 percent of its reflectance (Y) after dirt pickup resistance (DPUR) testing with UV exposure, or at least 87 percent or at least 89 percent or at least 91 percent or at least 93 percent. In some embodiments, the dry coating retains at least 82 percent of its reflectance (Y) after dirt pickup resistance (DPUR) testing without UV exposure, or at least 85 percent or at least 87 percent or at least 89 percent or at least 91 percent. In both cases, there is no maximum desired retention of reflection (Y), but retention above 98 percent may be unnecessary.

In some embodiments, the initial elongation-to-break of the dried coating (measured as described in the test methods) is at least 90% or at least 100% or at least 110% or at least 120%. There is no maximum desired elongation-to-break, but elongation-to-break above 400% is often unnecessary. In some embodiments, the same limits apply after 1000 hours accelerated weathering.

In some embodiments, the initial tensile strength of the dried coating (measured as described in the test methods) is at least 150 psi or at least 190 psi or at least 200 psi or at least 220 psi. There is no maximum desired tensile strength, but tensile strength above 500 psi is often unnecessary.

In some embodiments, the wet adhesion of the dried coating (measured as described in the test methods) is at least 300 N/m (1.7 pli) or at least 350 N/m (2 pli) or at least 370 N/m (2.11 pli) or at least 380 N/m (2.17 pli). There is no maximum desired adhesion.

In some embodiments, the permeance of the dried coating (measured as described in the test methods) is no more than 3000 ng (Pa-s-m2) or no more than 2875 or no more than 2800. There is no minimum desired permeance.

In some embodiments, the tear resistance of the dried coating (measured as described in the test methods) is at least 20 kN/m or at least 21 kN/m or at least 22 kN/m. There is no maximum desired tear resistance.

### Test Methods

When this document states that a property is measured, it is measured using the following test methods, unless it is clear from the context that a different method is intended.

| | |
|---|---|
| Glass Transition Temperature | ASTM E1356-08(2014) |
| Water Swelling | ASTM D471 (Average of 3 Samples) |
| Brightness of Filler | TAPPI 646 |
| Refractive Index | Niskanen, “Assessment of Refractive Index of Pigments by |
| | Gaussian Fitting of Light Backscattering Data in Context of |
| | the Liquid Immersion Method”, Applied Spectroscopy Vol. |
| | 64, Issue 5, pp. 558-561 (2010) |
| Dirt Pickup Resistance (DPUR) | ASTM D3719 |
| Reflectance (Y) of Coating | ASTM E1349 |
| Viscosity of Coating Compositions | ASTM D562 |
| Volume Solids | ASTM D2697 |
| Weight Solids | ASTM D1644 |
| Elongation to break (Initial) | ASTM D2370 |
| Elongation to Break (1000 h | |
| accelerated weathering) | |
| Initial Tensile Strength | |
| Permeance | ASTM D1653 |
| Tear Resistance | ASTM D624 |

### EXAMPLES

The following Examples illustrate some embodiments of the invention.

### Synthesis of Polystyrene-Coated Particle Emulsion

An emulsion containing an acidic polymer core (Core 1) is made as described in Examples 1-16 of U.S. Pat. No. 6,020,435. The emulsion contains about 30 weight percent core particles suspended in water.

A 5-liter, four necked round bottom flask is equipped with a paddle stirrer, thermometer, N₂ inlet and reflux condenser. Deionized (DI) water (500 g) is added to the flask and heated to 89° C. under N₂. Sodium persulfate (NaPS, 1.90 g in 20 g water) is added to flask immediately followed by 125 g of the Core 1 emulsion.

Monomer Emulsion 1 (ME 1) is prepared by mixing DI water (125.0 g), Disponil FES-32 emulsifier (10.0 g), styrene (436.8 g), linseed oil fatty acid (2.8 g), acrylonitrile (112.0 g), and divinyl benzene (7.0 g). ME 1 is added to the kettle over 75 min. The temperature of the reaction mixture is allowed to increase to 84° C. after 40 min and allowed to increase to 92° C. after 55 min. Two minutes after the start of ME 1 addition, a solution of acrylic acid (5.6 g) in DI water (35 g) is added to the flask. Forty minutes after the start of ME 1 addition, a solution of NaPS (0.5 g in 30 g water) is added to the kettle over 35 minutes. Upon completion of the ME 1 feed, the reaction is cooled to the temperature for the next step. The resulting emulsion contains acidic polymer cores coated with polystyrene polymer.

### Synthesis of OAP Binder 1

When the flask temperature reached 80° C., an aqueous mixture of ferrous sulfate and EDTA (20 g, 0.1 wt. % FeSO4, and 2 g, 1 wt. % EDTA) is added to the flask and cooling is continued to 72° C. When the flask temperature reaches 72° C., co-feeds including a solution of t-butylhydroperoxide (t-BHP 1.9 g) and NaPS (5.0 g) mixed with DI water (100 g), along with a separate solution of isoascorbic acid (IAA, 2.6 g in 100 g water) are both added simultaneously to the flask at 1.2 g/mins. Two min after the start of charging the co-feed solutions, Monomer Emulsion 2 (ME 2) is added to the flask over 55 min while allowing the temperature to rise to 80° C. without providing any external heat. ME2 contains DI water (240 g), Disponil FES 32 emulsifier (17.0 g), butyl acrylate (679.8 g), methyl methacrylate (328.2 g), and methacrylic acid (12.0 g). When ME2 is completely added, the co-feed solutions are stopped, and the batch is held for 5 min at 80° C. A solution of ammonium hydroxide (5 g NH₄OH, 28 wt. % aq.) mixed with DI water (5.0 g) is added to the flask along with hot (90° C.) DI water (225 g).

Monomer Emulsion 3 (ME 3) contains DI water (54.0 g), Disponil FES-32 emulsifier (3.0 g), butyl acrylate (104.4 g), methyl methacrylate (75.6 g), and 4-hydroxy TEMPO (3.0 g, 5 wt. % aq). ME 3 is fed to the flask over 5 min. Immediately after the ME 3 addition is complete, NH₄OH (35.0 g, 28 wt. % aq.) mixed with DI water (35 g) is added to the flask over 2 min. When NH₄OH addition is complete, the batch is held for 5 min. Additional co-feeds that contain a solution of t-BHP (1.5 g) in DI water (25 g), along with a separate solution of IAA (0.7 g) in water (25 g) are added simultaneously to the flask at a rate of 1.2 g/min. When the second co-feeds are completely added, the dispersion is cooled. When the flask temperature reaches 45° C., a solution of Acrysol ASE-60 (13.35 g in 53 g water) is added to the flask over a period of 10 minutes, and cooling is continued to 25° C. The resulting dispersion is filtered to remove any coagulum. The filtered OAP Binder 1 dispersion has a solids content of 49.0%.

### Synthesis of OAP Binder 2

The procedure for making OAP Binder 1 is repeated, but ME 2 contains DI water (240 g), Disponil FES 32 emulsifier (17.0 g), butyl acrylate (868.8 g), methyl methacrylate (139.2 g), and methacrylic acid (12.0 g). The filtered OAP Binder 2 dispersion had a solids content of 48.9%.

### Synthesis of OAP Binder 3

The procedure for making OAP Binder 1 is repeated, but ME 2 contains DI water (240 g), Disponil FES 32 emulsifier (17.0 g), butyl acrylate (679.8 g), methyl methacrylate (305.4 g), acetoacetoxy ethyl methacrylate (22.8 g) and methacrylic acid (12.0 g). The filtered OAP Binder 3 dispersion had a solids content of 48.6%.

### Synthesis of OAP Binder 4

The procedure for making OAP Binder 1 is repeated, but ME 2 contains DI water (240 g), Disponil FES-32 emulsifier (17.0 g), butyl acrylate (868.8 g), methyl methacrylate (116.4 g), acetoacetoxy ethyl methacrylate (22.8 g), and methacrylic acid (12.0 g). The filtered OAP Binder 4 dispersion had a solids content of 48.7%.

### Synthesis of OAP Binder 5

The procedure for making OAP Binder 1 is repeated, but:
ME 2 contains DI water (240 g), Disponil FES-32 emulsifier (17.0 g), butyl acrylate (679.8 g), methyl methacrylate (316.2 g), diacetone acrylamide (DAAm, 12.0 g) and methacrylic acid (12.0 g).
When the flask reaches 45° C., a slurry solution of adipic dihydrazide (ADH, 6 g in 30 g water) was added to the flask before the Acrysol ASE-60 is added.
   The filtered opaque OAP Binder 5 dispersion has a solids content of 48.3%.

### Synthesis of OAP Binder 6

The procedure for making OAP Binder 1 is repeated, but:
ME 2 contains DI water (240 g), Disponil FES 32 emulsifier (17.0 g), butyl acrylate (868.8 g), methyl methacrylate (127.2 g), diacetone acrylamide (DAAm, 12.0 g), and methacrylic acid (12.0 g).
When the flask reaches 45° C., a slurry solution of adipic dihydrazide (ADH, 6 g in 30 g water) was added to the flask before the Acrysol ASE-60 is added.
   The filtered OAP Binder 6 dispersion has a solids content of 48.3%.

### Formulation of Inventive Aqueous Coating Compositions:

Six aqueous coating compositions (IE1 to IE6) are made using the procedure below. The contents of each aqueous coating composition are listed in Table 2. The binder for each aqueous coating composition is an OAP Binder. The binder in Inventive Example 1 (IE1) is OAP Binder 1, the binder in Inventive Example 2 (IE2) is OAP Binder 2, the binder in Inventive Example 3 (IE3) is OAP Binder 3, the binder in Inventive Example 4 (IE4) is OAP Binder 4, the binder in Inventive Example 5 (IE5) is OAP Binder 5, the binder in Inventive Example 6 (IE6) is OAP Binder 6.

### Grind Phase:

Use 1× SS Grind Pot (4″ diameter) on Melton Mixers 1 hp Model CM-100 Lab Disperser w/2″ Cowles Blade.
Add water, dispersants and defoamer to grind pot and mix @ 400-600 rpm.
Dispense Kathon LX 1.5% directly to the grind pot.
Pre-weigh CaCO₃, TiO₂ and ZnO into separate containers.
Sift in dry materials to vortex at 800 rpm slowly increasing to 1700 rpm to maintain vortex.
Disperse the grind at 1700-2000 rpm to maintain donut vortex for 20 minutes.

### Let Down Phase:

Pre-weigh the binder into separate container.
Reduce rpm to 300-400 then add pre-weighed binder and add defoamer.
Add ammonia.
Premix UCAR™ Filmer IBT and BioBan 200 and add slowly to vortex.
Pre-weigh CELLOSIZE™ QP52000H glycol ether thickener and Propylene Glycol separately while stirring with spatula then add slowly to vortex increasing rpm to 1000. Rinse pre-mix container with water and add to the mix.
Maintain agitation for 10 minutes @ 900-1000 rpm to keep surface edges moving.

TABLE 2
Inventive Example Formulations

| Name | Pounds | Gallons |
|---|---|---|
| Grind Phase | | |
| Water | 102.19 | 12.24 |
| TAMOL ™ 901 dispersant | 6.32 | 0.63 |
| Dee Fo 1015 defoamer | 1.52 | 0.21 |
| Kathon LX 1.5%, biocide | 1.52 | 0.18 |
| Omyacarb 3, 3 μ CaCO₃ | 329.94 | 14.64 |
| Ti-Pure R-960 TiO₂ | 27.52 | 0.85 |
| Let Down Phase | | |
| Binder Emulsion | 657-667 | 76.4-77.5 |
| Dee Fo 1015, defoamer | 1.52 | 0.21 |
| UCAR ™ Filmer IBT glycol ether film | 7.59 | 0.96 |
| forming agent | | |
| Bioban 200 biocide | 6.07 | 0.67 |
| Ammonia (28%), base | 3.04 | 0.40 |
| Propylene Glycol | 14.16 | 1.64 |
| CELLOSIZE ™ QP52000H glycol ether thickener | 3.04 | 0.36 |
| Water | 1.04 | 0.13 |
| Totals | 1080.79 | 100.00 |

Comparative Example 1 (CE1) is made using the same procedures with the contents in Table 3. CE1 uses a conventional binder, rather than an OAP binder, and use substantially more titanium dioxide than the inventive examples.

TABLE 3
Comparative Example 1 Formulation

| Name | Pounds | Gallons |
|---|---|---|
| Grind Phase | | |
| Water | 101.00 | 12.10 |
| TAMOL ™ 851 dispersant | 3.50 | 0.35 |
| Potassium Tripolyphosphate (KTPP) dispersant | 1.00 | 0.05 |
| Dee Fo 1015 defoamer | 1.50 | 0.21 |
| Kathon LX 1.5% biocide | 1.50 | 0.18 |
| Omyacarb 3, 3 μ CaCO₃ | 300.00 | 13.31 |
| Ti-Pure R-960 TiO₂ | 50.00 | 1.55 |
| Zoco 101 zinc oxide | 35.00 | 0.76 |
| End Grind | 493.50 | 28.51 |
| Let Down | | |
| RHOPLEX ™ EC-2885^{a} binder | 580.00 | 67.42 |
| Dee Fo 1015 defoamer | 1.50 | 0.21 |
| UCAR ™ Filmer IBT | 7.50 | 0.95 |
| Bioban 200 biocide | 6.00 | 0.66 |
| Ammonia (28%) | 3.00 | 0.40 |
| Propylene Glycol | 14.00 | 1.62 |
| WALOCEL ™ MT 30000 PV glycol ether thickener | 3.00 | 0.36 |
| Water | 0.52 | 0.06 |
| Totals | 1109.02 | 100.18 |

^{a}Rhoplex EC-2885 contains benzophenone to improve dirt pickup resistance.

Comparative Example 2 (CE2) is made using the same procedures with the contents in Table 4. CE2 uses a conventional binder and uses ROPAQUE ULTRA™ emulsion, a hollow-core polymer filler, in place of part of the calcium carbonate filler. In the Let Down Phase, the Propylene Glycol, glycol ether thickener and water are premixed before they are added.

TABLE 4
Comparative Example 2 Formulation

| Name | Pounds | Gallons |
|---|---|---|
| Grind | | |
| Water | 10.02 | 1.2 |
| TAMOL 851 dispersant | 5.00 | 0.50 |
| Potassium Tripolyphosphate (KTPP) dispersant | 1.50 | 0.07 |
| Dee Fo 1015 defoamer | 1.50 | 0.21 |
| Kathon LX 1.5% biocide | 1.50 | 0.18 |
| Snowhite 12 CaCO₃ | 245.89 | 10.90 |
| Ti-Pure R-960 TiO₂ | 72.52 | 2.24 |
| Zoco 101 zinc oxide | 43.51 | 0.94 |
| ROPAQUE ULTRA ™ emulsion | 226.48 | 26.49 |
| End Grind | 607.92 | 42.74 |
| Let Down | | |
| RHOPLEX EC-1791 binder | 466.39 | 53.61 |
| Dee Fo 1015 defoamer | 1.50 | 0.21 |
| UCAR ™ Filmer IBT | 6.00 | 0.76 |
| Bioban 200 biocide | 5.50 | 0.60 |
| Ammonia (28%) | 1.00 | 0.13 |
| Propylene Glycol | 14.00 | 1.62 |
| WALOCEL ™ MT 30000 PV glycol ether thickener | 3.60 | 0.33 |
| Water | 3.67 | 0.44 |
| End Let Down | 497.99 | 57.26 |
| Totals | 1105.91 | 100.00 |

Each ERC composition is tested for glass transition temperature, water swelling, reflectance and dirt pickup resistance according to the Test Methods. Results are shown in Table 5. Table 5 shows that:
The coatings in the Inventive Examples have reflectance similar to a conventional coating (CE1), even though the inventive coatings contain less titanium dioxide.
The coatings in the Inventive Examples have water swelling similar to a conventional coating (CE1) and lower than a coating made with conventional hollow-core filler (CE2).
The coatings in the Inventive Examples have dirt pickup resistance that is comparable to conventional coatings (CE1 and CE2), even though the conventional coatings have benzophenone and the inventive coatings do not.

Comparative Example 3 (CE3) is made using the same procedures with the contents in Table 6. CE3 uses a commercial binder conventional binder, rather than an OAP binder, and use substantially more titanium dioxide than the inventive examples.

TABLE 6
Comparative Example 3 Formulation

| Name | Pounds | Gallons |
|---|---|---|
| Grind Phase | | |
| Water | 101.00 | 12.10 |
| TAMOL ™ 851 dispersant | 3.50 | 0.35 |
| Potassium Tripolyphosphate (KTPP) dispersant | 1.00 | 0.05 |
| Dee Fo 1015 defoamer | 1.50 | 0.21 |
| Kathon LX 1.5% biocide | 1.50 | 0.18 |
| Omyacarb 3, 3 μ CaCO₃ | 300.00 | 13.31 |
| Ti-Pure R-960 TiO₂ | 50.00 | 1.55 |
| Zoco 101 zinc oxide | 35.00 | 0.76 |
| End Grind | 493.50 | 28.51 |
| Let Down | | |
| RHOPLEX ™ EC-2540^{b} binder | 580.00 | 67.42 |
| Dee Fo 1015 defoamer | 1.50 | 0.21 |
| UCAR ™ Filmer IBT | 7.50 | 0.95 |
| Bioban 200 biocide | 6.00 | 0.66 |
| Ammonia (28%) | 3.00 | 0.40 |
| Propylene Glycol | 14.00 | 1.62 |
| WALOCEL ™ MT 30000 PV glycol ether thickener | 3.00 | 0.36 |
| Water | 0.52 | 0.06 |
| Totals | 1109.02 | 100.18 |

^{b}Rhoplex EC-2540 contains benzohenone to improve dirt pickup resistance.

Inventive examples 7 and 8 (IE7 and IE8) contain an OAP binder that is used in combination with a benzophenine-containing conventional binder. IE7 and IE8 is made using the same procedures with the contents in Table 6. IE7 and IE8 is prepared by cold blending the commercial latex with OAP biner 1 prior to addition in the formulation. The OAP-commercial binder blend is based on the binder solids weight ratio listed in Table 7.

TABLE 5
Composition of series of OAP samples.

| | | | | | | Initial | | |
|---|---|---|---|---|---|---|---|---|
| | | | Peak | Peak Swell | 7 days Swell | Reflectance | DPUR | DPUR |
| Ex | Benzophenone | Tg | Swell hrs | (%) | (%) | (Y) | w/UV | w/o UV |
| CE1 | Yes | −30 | 6 hrs | 12.22% | 7.51% | 90.68% | 98.9% | 86.0% |
| IE1 | None | −5.33 | 24 hrs | 9.86% | 9.11% | 89.85% | 95.0% | 93.5% |
| IE2 | None | −27.27 | 30 hrs | 10.47% | 10.37% | 87.78% | 87.1% | 85.7% |
| IE3 | None | −7.04 | 27 hrs | 9.30% | 8.36% | 90.19% | 91.7% | 92.6% |
| IE4 | None | −27.17 | 27 hrs | 9.43% | 8.99% | 87.59% | 90.8% | 91.8% |
| IE5 | None | −6.34 | 27 hrs | 6.43% | 6.46% | 87.55% | 92.5% | 94.1% |
| IE6 | None | −28.61 | 51 hrs | 8.25% | 8.72% | 86.10% | 91.7% | 94.5% |
| CE2 | Yes | −35 | 72 hrs | 28.66% | 28.50% | 95.33% | 89.9% | 94.4% |

Comparative Example 3 (CE3) is made using the same procedures with the contents in Table 6. CE3 uses a conventional binder, rather than an OAP binder, and uses substantially more titanium dioxide than the inventive examples.

TABLE 6
Comparative Example 3 Formulation

| Name | Pounds | Gallons |
|---|---|---|
| Grind Phase | | |
| Water | 101.00 | 12.10 |
| TAMOL ™ 851 dispersant | 3.50 | 0.35 |
| Potassium Tripolyphosphate (KTPP) dispersant | 1.00 | 0.05 |
| Dee Fo 1015 defoamer | 1.50 | 0.21 |
| Kathon LX 1.5% biocide | 1.50 | 0.18 |
| Omyacarb 3, 3 μ CaCO₃ | 300.00 | 13.31 |
| Ti-Pure R-960 TiO₂ | 50.00 | 1.55 |
| Zoco 101 zinc oxide | 35.00 | 0.76 |
| End Grind | 493.50 | 28.51 |
| Let Down | | |
| RHOPLEX ™ EC-2540^{b} binder | 580.00 | 67.42 |
| Dee Fo 1015 defoamer | 1.50 | 0.21 |
| UCAR ™ Filmer IBT | 7.50 | 0.95 |
| Bioban 200 biocide | 6.00 | 0.66 |
| Ammonia (28%) | 3.00 | 0.40 |
| Propylene Glycol | 14.00 | 1.62 |
| WALOCEL ™ MT 30000 PV glycol ether thickener | 3.00 | 0.36 |
| Water | 0.52 | 0.06 |
| Totals | 1109.02 | 100.18 |

^{b}RHOPLEX ™ EC-2540 contains benzohenone to improve dirt pickup resistance.

Inventive Examples 7 and 8 (IE7 and IE8) contain an OAP binder that is used in combination with a benzophenone-containing conventional binder. IE7 and IE8 are made using the same procedures with the contents in Table 6. IE7 and IE8 are prepared by cold blending the commercial latex with OAP binder 1 prior to addition in the formulation. The OAP-commercial binder blend is based on the binder solids weight ratio listed in Table 7.

TABLE 7
Composition of series of OAP blends with commercial
benzophenone containing binders

| | | Blend | DPUR | DPUR |
|---|---|---|---|---|
| Ex | Benzophenone | OAP/Binder | w/UV | w/o UV |
| CE3 | Yes | NA | 95.8% | 58.2% |
| IE7 | Yes | 50/50 | 92.5% | 65.8% |
| IE8 | Yes | 75/25 | 92.3% | 82.4% |

1. An aqueous coating composition that comprises:
a) a water-insoluble filler that comprises from 5 weight percent to less than 20 weight percent of high-reflectance inorganic pigment;
b) an opacifying acrylic polymers binder; and
wherein the aqueous coating composition has a pigment volume content of no more than 55 percent.

2. The aqueous coating composition of claim 1 wherein the opacifying acrylic polymers binder comprises particles that contain (1) an inner shell that comprises a polymer with a glass-transition temperature of at least 50° C.; and (2) an outer shell that comprises a polymer with a glass transition temperature below 50° C.

3. The aqueous coating composition of claim 2 wherein the inner shell polymer has a glass-transition temperature of at least 65° C., and the outer shell polymer has a glass transition temperature of no more than 20° C.

4. The aqueous coating composition of claim 3 wherein the outer shell polymer has a glass transition temperature of no more than 0° C.

5. The aqueous coating composition of claim 3 wherein the inner shell polymer is a polystyrene polymer, and the outer shell polymer is an acrylic polymer.

6. The aqueous coating composition of claim 3 wherein the pigment volume content of the aqueous coating composition is from 40 to 50 percent.

7. The aqueous coating composition of claim 3 wherein the weight ratio of outer shell to inner shell in the opacifying acrylic polymers binder particles is from 1:5 to 1:1.5.

8. The aqueous coating composition of claim 3 wherein the filler contains from 6 to 18 weight percent high-reflectance pigment having a refractive index above 2.

9. The aqueous coating composition of claim 8 wherein the high-reflectance pigment comprises titanium dioxide.

10. The aqueous coating composition of claim 9 wherein the filler contains from 8 to 12 weight percent high-reflectance pigment.

11. The aqueous coating composition of claim 3, wherein the aqueous coating composition has a viscosity at 25° C. of from 85 KU to 141 KU, contains at least 50 volume percent solids, and contains at least 60 weight percent solids.

12. A process for making a coated substrate comprising the steps of applying the aqueous coating composition of claim 1 to a substrate that forms part of a roof of a structure; and permitting the aqueous coating composition to dry, under conditions such that the filler and binder adhere to the substrate.

13. A coated substrate that forms part of a roof, wherein the coated substrate.

14. The coated substrate of claim 13 wherein the dry coating composition has an initial reflectance of at least 82 percent.

15. The coated substrate of claim 13 wherein the dry coating composition retains at least 89 percent of reflectance when tested for Dirt Pickup Resistance without UV exposure.
